(19) United States
(12) Patent Application Publication
(10) Pub. No.: US 2010/0027786 A1
(43) Pub. Date: Feb. 4, 2010

(54) DYNAMIC ENCRYPTION AUTHENTICATION

(76) Inventors: Patrick Faith, Pleasanton, CA (US); Ayman Hammad, Pleasanton, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/031,036

(22) Filed: Feb. 14, 2008

(51) Int. Cl. H04L 9/00; H04L 9/28

(52) U.S. Cl. 380/44; 380/28; 380/29

(57) ABSTRACT

A method is disclosed. The method includes generating a uniquely derived data string using personalized information and a first encryption algorithm, generating at least one uniquely derived key using the uniquely derived data string, and creating a dynamic verification value using a second encryption algorithm using the at least one uniquely derived key, wherein the first encryption algorithm is different than the second encryption algorithm.

### CROSS-REFERENCES TO RELATED APPLICATIONS

None.

### BACKGROUND

As methods and devices for engaging in financial transactions have increased, old problems such as fraud and counterfeiting persist.

One of the primary sources of fraud, which is prevalent in the credit card industry is skimming. Skimming refers to the electronic copying of a card's magnetic stripe data to create counterfeit cards.

Skimming is predominantly a phenomenon afflicting magnetic stripe based transactions. This is because the magnetic stripe, which is placed on the back of a transaction card and stores a variety of data on three separate tracks, is a passive medium. In other words, the digital content of the magnetic stripe can be perfectly copied, without any difference between the copy and the original.

One of the primary means by which skimming can be prevented is for the consumer to closely monitor the whereabouts of his transaction card. This may allow the consumer to prevent the card from being swiped through inappropriate devices. However, as contactless cards evolve, the classic skimming problem comes along with it. In fact, in a wireless environment the opportunity to skim magnetic stripe data is more prevalent. In a wireless environment, a potential skimmer need not physically possess the card to be skimmed nor have access to any of the physical equipment (e.g. POS terminal, communication lines, etc.) which is required for skimming in a wire based environment. A skimmer can, without the knowledge of the consumer or merchant, intercept the wireless transaction and copy the data being transmitted from the card to POS terminal.

To address the above problems, some have proposed using a dCVV or a dynamic card verification value. Dynamic card verification values change with each use of a portable consumer device, so that each transaction has a unique identifier. The dynamic card verification value can be created using an encryption algorithm such as DES (dynamic encryption standard). While the use of DES can be sufficient, it would be desirable to enhance the security in a DCVV type process. Any security enhancement would desirably take place while minimizing changes to the existing payments security infrastructure.

Embodiments of the invention address these and other problems, individually and collectively.

### BRIEF SUMMARY

Embodiments of the present invention are directed to systems and methods for generating verification values.

One embodiment of the invention is directed to a method comprising generating a uniquely derived data string using personalized information and a first encryption algorithm, generating at least one uniquely derived key using the uniquely derived data string, and creating a dynamic verification value using a second encryption algorithm using the at least one uniquely derived key. The first encryption algorithm is different than the second encryption algorithm.

Another embodiment of the invention is directed to a computer readable medium comprising code for generating a uniquely derived data string using personalized information and a first encryption algorithm code for generating at least one uniquely derived key using the uniquely derived data string, and code for creating a dynamic verification value using a second encryption algorithm using the at least one uniquely derived key, wherein the first encryption algorithm is different than the second encryption algorithm.

Another embodiment of the invention is directed to a service provider computer comprising a processor, and a computer readable medium comprising instructions for generating a uniquely derived data string using personalized information and a first encryption algorithm, generating at least one uniquely derived key using the uniquely derived data string, and creating a dynamic verification value using a second encryption algorithm using the at least one uniquely derived key. The first encryption algorithm is different than the second encryption algorithm.

These and other embodiments of the invention are described in further detail below in the Detailed Description and with reference to the Figures.

### BRIEF DESCRIPTION OF THE DRAWINGS

FIG. 1 depicts a method for generating unique derived keys from data residing on a portable consumer device.

FIG. 2 depicts a method of creating an encrypted data block for use in an embodiment of the present invention.

FIG. 3 depicts a method for extracting portions of an encrypted data block for creating a dynamic card verification value according to an embodiment of the present invention.

FIG. 4 depicts an exemplary record format for use in an embodiment of the present invention.

FIG. 5 depicts an alternative exemplary format for use in an embodiment of the present invention.

FIG. 6 is a flowchart of a preferred method of utilizing a dynamically created verification value to authenticate a transaction.

FIG. 7 is a flowchart of an alternate method of utilizing a dynamically created verification value to authenticate a transaction.

FIG. 8 shows typical components that can be present in a computer.

### DETAILED DESCRIPTION

Before the present methods are described, it is to be understood that this invention is not limited to the particular methodologies, devices or protocols described, as these may vary. It is also to be understood that the terminology used in the description is for the purpose of describing the particular versions or embodiments only, and is not intended to limit the scope of the present invention which may be limited only by the appended claims. In particular, although the present invention is described in conjunction with financial transactions, it may be appreciated that the present invention may find use in any electronic exchange of data.

It is also noted that as used herein and in the appended claims, the singular forms “a”, “an”, and “the” include plural reference unless the context clearly dictates otherwise. Thus, for example, reference to a “key” is a reference to one or more keys and equivalents thereof known to those skilled in the art, and so forth.

Generally, embodiments of the invention provide improved methods and systems for dynamically generating a card verification value for each transaction and for utilizing such value to verify that the payment service is authentic and has not been skimmed. The dynamically generated verification value is generated on the portable consumer device, embedded into the payment data, and transmitted to a point of sale terminal. In an alternate embodiment, payment data is received from a portable consumer device, a verification value is generated by a point of sale terminal, and the verification value is embedded into the payment data. In the examples below, a Card Verification Value (referred to herein as the “dCVV”) is discussed in detail. However, it is noted that embodiments of the invention are not limited to the use of cards.

In an embodiment, data received by the point of sale terminal is interpreted as simply payment data (e.g. standard magnetic stripe Track 1 and/or Track 2 data without an embedded dCVV) by the point of sale terminal. The point of sale terminal passes on the received data to a payment network which, in turn, passes the data on to the service provider. If the service provider determines the transaction is one for which a dCVV is required, the service provider independently generates a verification value. If the verification value generated by the service provider does not match the dCVV received from the portable consumer device, the transaction is identified as potentially fraudulent and disapproved.

In an alternate embodiment, data is received by the point of sale terminal and is used by the point of sale terminal to generate a verification value. The point of sale terminal passes on the received data to a payment network which, in turn, passes the data on to the service provider. The service provider independently generates a verification value. If the verification value generated by the service provider does not match the dCVV received from the point of sale terminal, the transaction is identified as potentially fraudulent and disapproved.

As explained above, in some instances, a dynamic data element such as a counter (or other type of data element that can change) can be received at a back end computer along with a dCVV generated by a portable consumer device. The back end computer can determine if the counter is within a predetermined range. If it is, then the back end computer can independently generate another dCVV. For example, if the received dCVV and the generated dCVV match (or is within a predetermined range), then the transaction can be considered authentic.

The back end computer can comprise a processor, and a computer readable medium comprising code for performing any of the functions described herein. The computer readable medium may be in any suitable form including a memory chip, a magnetic stripe, optical disk, etc.

For purposes of this application, the term “portable consumer device” can include any device with or without a microprocessor which may be used in a transaction or data exchange as described herein. Without limiting the generality of the foregoing, “portable consumer device” can include an integrated circuit card (also commonly known as a smartcard), a memory card, a cellular telephone, a personal digital assistant, a mobile electronic device, or a computer.

For purposes of this application, “contactless” or “wireless” can include any communications method or protocol, including proprietary protocols, in which data are exchanged between two devices without the need for the devices to be physically coupled. Without limiting the generality of the foregoing, “contactless” or “wireless” can include data transmissions by laser, radio frequency, infrared communications, Bluetooth, or wireless local area network.

For purposes of this application, the term “payment service” can include any application deployed on a portable consumer device which causes the exchange of data between the portable consumer device and any other device or location. It should be appreciated that “payment service” is not limited to financial applications.

For purposes of this application, “payment data” can include, with respect to financial applications those data elements used by the payment service to execute a transaction, and with respect to non-financial transactions any necessary data elements exclusive of the present invention. For example, when the payment service is used in a magnetic stripe credit card transaction, “payment data” would comprise Track 1 and/or Track 2 data, as that is understood by one of ordinary skill in the credit card industry, such as the primary account number, expiration date, service codes, and discretionary data. “Payment data” may also comprise a unique card identification number or a unique identification number for a service provider.

In an embodiment of the invention, the payment data may reside in memory located in the portable consumer device. The portable consumer device may also maintain a dynamic data element such as an application transaction counter (ATC), which may be a value of any suitable length. The ATC may initially be set by the service provider to a predetermined value. Thereafter, the ATC may be incremented with each transaction. Alternately, the ATC may be decremented from its initial predetermined value with each transaction. In addition, the service provider which deployed the payment service may maintain a corresponding ATC accessible to the service provider's computer. As discussed in more detail below, this corresponding ATC is used to identify payment services which may have been skimmed. In an alternate embodiment, a cryptogram, digital signature, or hash value based on transaction data may be used in place of or in conjunction with the ATC. Other dynamic data elements include the time of day, date, etc.

One embodiment of the invention is directed to a method comprising generating a uniquely derived data string using personalized information (e.g., an account number, birthdate, social security number, etc.) associated with a consumer and a first encryption algorithm, generating at least one uniquely derived key using the uniquely derived data string, and creating a dynamic verification value using a second encryption algorithm using the at least one uniquely derived key. The first encryption algorithm that is used to form the uniquely derived key is different than the second encryption algorithm that is used to form the dynamic verification value.

In preferred embodiments, the first and encryption algorithms are different and may be selected from well known encryption algorithms including DES, triple DES, and AES. Other well known encryption algorithms may also be used in embodiments of the invention.

DES is a block-cipher employing a 56-bit key that operates on 64-bit blocks. It was standardized by the US government in the 1970s; for many years DES was considered the ‘gold standard’ of cryptographic algorithms.

Triple DES (3DES) which also known as Triple Data Encryption Algorithm is a variant of DES in which data is encrypted three times with standard DES using either two or three different keys. Triple DES was derived from DES. Triple DES is a block cipher created by using the DES algorithm three successive times. Triple DES with a three different keys has a key length of 168 bits (that is three 56-bit DES keys). In the Triple DES standard, the data is encrypted with the first key, decrypted with the second key, and finally encrypted again with the third key.

AES (Advanced Encryption Standard) is cryptographically stronger successor to the Data Encryption Standard (DES); the selection of the AES algorithm involved submissions from around the world and was overseen by the US government's National Institute of Standards (NIST). It was adopted by NIST in May of 2002. AES can use keys with a length of 128, 192, or 256 bits to encrypt blocks with lengths of 128, 192, or 256 bits.

In preferred embodiments of the invention, the first encryption algorithm that is used to form the uniquely derived keys is an AES algorithm, while the second encryption algorithm that uses to the uniquely derived keys to form the dynamic verification value is a DES or triple DES algorithm. AES is a stronger encryption algorithm than DES or triple DES, and can be used by a service organization (e.g., an issuer, payment processing organization) to form uniquely derived keys. AES, however, is not as widely used as DES or triple DES. However, a service organization can change its key derivation system to use AES without too much difficulty.

DES or triple DES can be used in POS terminals, portable consumer devices, etc. to create the dynamic verification values. Since DES and triple DES encryption algorithms are used in many existing POS terminals and the like, these POS terminals can continue to use DES or triple DES. Embodiments of the invention can greatly improve upon existing verification value processes, without requiring widespread changes in existing payment security systems. Also, because different combinations of encryption algorithms are used, it is more difficult for a potential skimmer to unencrypt any data that the skimmer receives, since the skimmer will also need to determine which encryption algorithms were used to encrypt the skimmed and encrypted data.

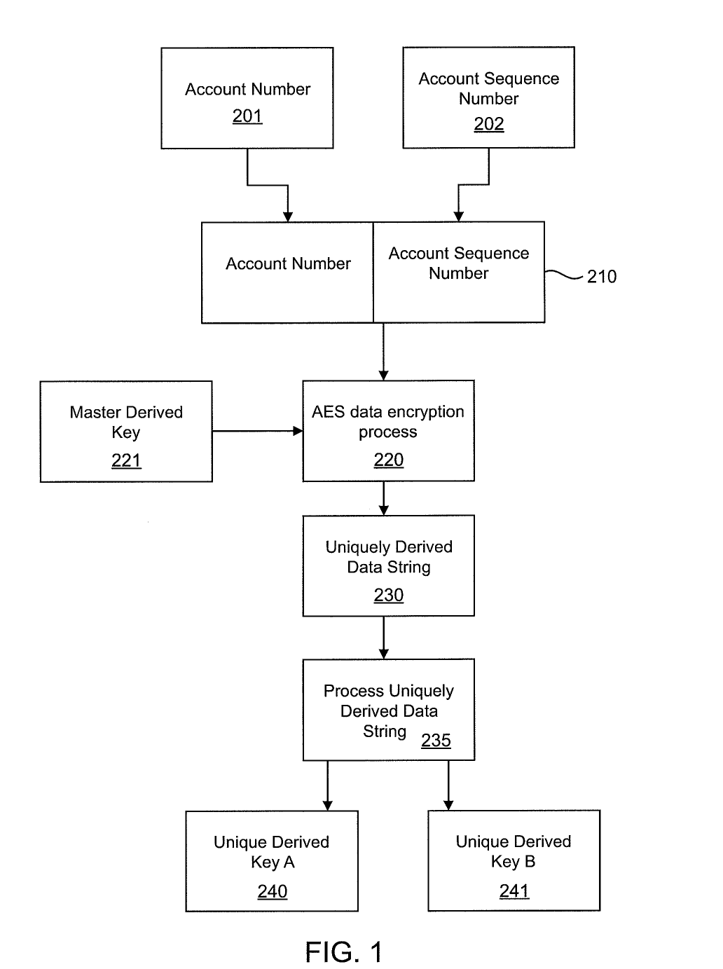

FIG. 1 shows the methodology for deriving two unique keys which are utilized in the preferred embodiment. The account number 201 and the account sequence number 202 are concatenated together to create a concatenated value 210. If necessary, the concatenated value 210 may be padded with zeroes, or some other value and may accommodate additional discretionary data comprising one or more data elements, to create a string of a predetermined fixed length. In one embodiment, the concatenated value 210 may be 256 bits in length, although the concatenated value is not limited to being this length and may accommodate additional discretionary data comprising one or more data elements.

The concatenated value 210 is then encrypted 220 using a first encryption algorithm using a master derivation key 221 as the encryption key for each encryption stage. The encryption utilized may any suitable type of encryption methodology. For example, this encryption step may utilize an AES encryption algorithm. The master derivation key may be a 256 bit key compatible with an AES encryption algorithm. The value resulting from the encryption step 220 may be a uniquely derived data string 230 that may be 256 bits.

The 256 bit data string 230 may then be processed (step 235) to generate two uniquely derived keys, such as UDKA 240 and UDKB 241. The formed keys can be used with a second encryption algorithm. For example, in the 256 bit data string 230, the leftmost and rightmost 64 bit data stings may respectively be UDKA 240 and UDKB 241. These 64 bit data strings can be keys that are used in a DES or triple DES encryption algorithm.

The derivation of UDKA 240 and UDKB 241 from the data string 230 may take any form, including assigning the value of the leftmost half of the data string 230 to UDKA 240, and assigning the value of the rightmost half of the data string 230 to UDKB 241. Alternatively, the UDKA 240 may be derived by selecting alternating or other predetermined bit sequences from the data string 230 while the remaining bits are assigned to UDKB 241. Furthermore, there is no requirement that UDKA 240 and UDKB 241 are of equal length. Also, there is no requirement that two uniquely derived keys be formed from the uniquely derived data string. For instance, one key could be generated from the uniquely derived data string.

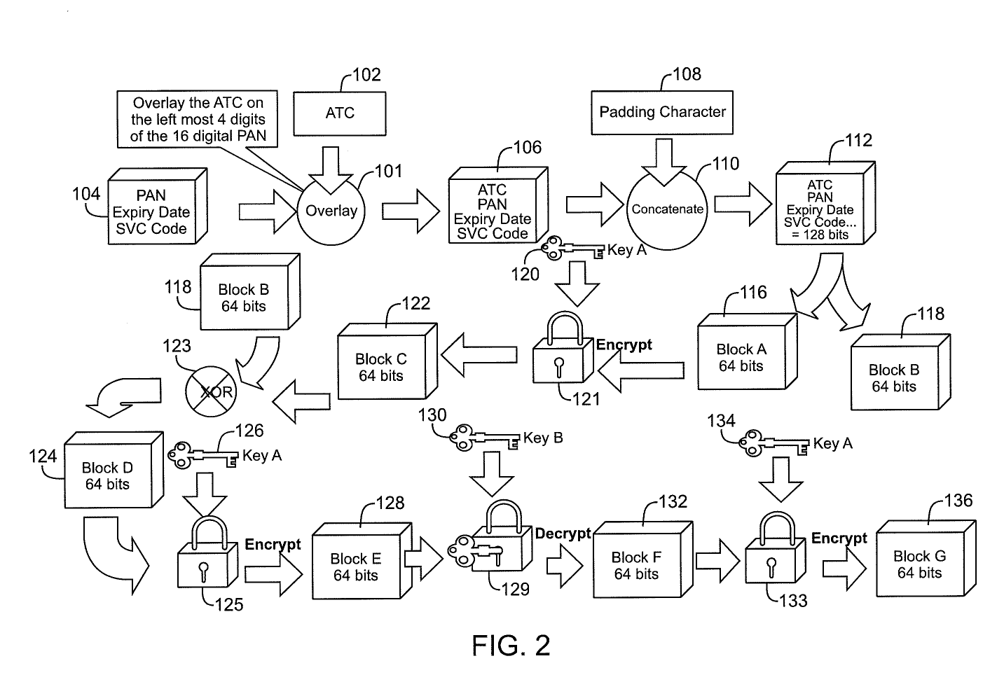

Once uniquely derived keys are generated, they can be used to create verification values. For example, each time the payment service is initiated, a dCVV is generated on the portable consumer device for authentication purposes. FIG. 2 shows an exemplary method of generating a dCVV for each transaction. Initially, a numeric string of predetermined length is created. This numeric string is created by overlaying 101 the ATC 102 over the corresponding leftmost digits of the account number for the payment service or PAN 104. This numeric string is concatenated on the right with the expiration date for the payment service and the service code to produce a concatenated value 106. The account number, and expiration date, may be examples personalized information that can be used to generate verification values. Because personalized information is used to generate the verification value, the verification value can be personal to a portable consumer device or consumer. “Personalized information” can include information specifically associated with a consumer (e.g., birthdate), and/or information that is specifically associated with a portable consumer device (e.g., expiration date).

If necessary, padding characters 108 are concatenated 110 on the right of the concatenated value 106 to form a numeric string 112 with a predetermined fixed length. In one embodiment, this numeric string 112 is 128-bits in length, although a numeric string of any length may be used. The padding characters 108 may consist of a stream of 0's, 1's, or any other numeric value that is known both to the portable consumer device and the service provider. The numeric string 112 is bisected into two blocks of equal length, Block A 116 and Block B 118. Block A 116 is then encrypted 121 using a second encryption algorithm with a first encryption key 120 such as UDKA. The result of the encryption step 121 is Block C 122 of length equal to Block A 116. Block C 122 is then exclusively OR'ed (XOR) 123 with Block B 118 resulting in Block D 124. Block D 124 is then encrypted 125 with a second encryption key 126 such as UDKA to produce Block E 128. Block E 128 is then decrypted 129 using a decryption key 130 such as UDKB to produce Block F 132. Block F 132 is then encrypted 133 using a fourth encryption key 134 such as UDKA to produce Block G 136.

Some or of all of the encryption algorithms (e.g., steps 121, 125, 133, etc.) that use UDKA or UDKB to encrypt the above-described data blocks in FIG. 2 can include DES, Triple DES, or any other suitable encryption algorithm that is different than the encryption algorithm used to form UDKA and UDKB. Combinations of different encryption algorithms can also be used in FIG. 2.

It will be apparent to one of ordinary still in the art that the first encryption key 120, the second encryption key 126, the third encryption key 130 and the fourth encryption key 134 may take any preselected value. In an embodiment of the present invention, the first encryption key 120, the second encryption key 126, and the fourth encryption key 134 are equivalent and of a different value from the third encryption key 130. Other permutations of the encryption key values utilized in the methodology of FIG. 2 are within the scope of the present invention.

In one embodiment, the first encryption key 120, the second encryption key 126, the third encryption key 130, and the fourth encryption key 134 take the value of unique keys derived from data existing on the portable consumer device. Upon deployment, each payment service is personalized by the service provider with a master derivation key. The master derived key may be deployed with payment services in batches (i.e. multiple payment services receive the same master derived key) or individually. Each portable consumer device may be personalized with the functionality to derive keys unique to the payment service.

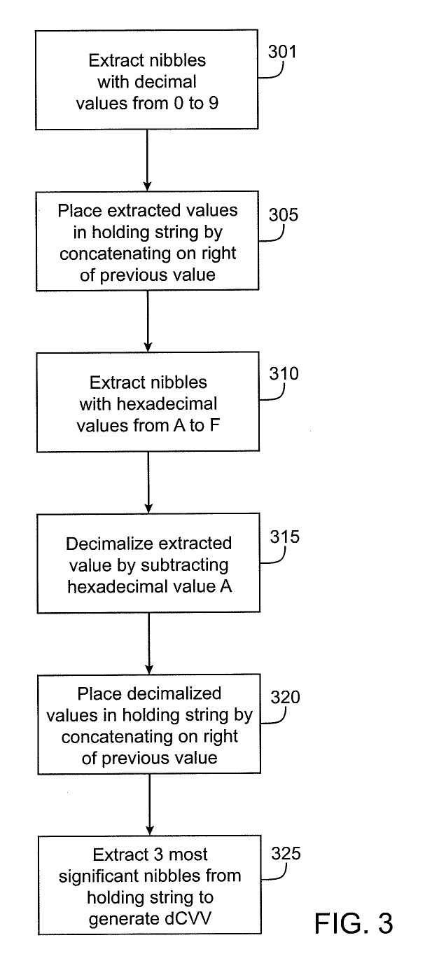

FIG. 3 describes the further processing that can be used to generate the dCVV. Each nibble (4-bit grouping) of the value stored in Block G 136 is subjected to two separate iterative processes to evaluate the value of each nibble. As shown in FIG. 3, beginning with the most significant (i.e. left most) digit of Block G 136 and examining each sequential nibble, if a nibble contains a value ranging from zero to nine, inclusive, that value is extracted 301 and placed in a new numeric string 305, referred to herein as a holding string, by concatenating the extracted value to the right of the previously extracted value, if any. The result may be that the holding string contains a series of values ranging from zero to nine, inclusive, which appear from left to right in the holding string in the same sequence in which they appear in Block G 136.

A second evaluation is then performed again beginning with the most significant digit of Block G 136 and examining each sequential nibble. If a nibble contains a hexadecimal value ranging from ten (A) to fifteen (F), inclusive, that value is extracted 310. The extracted value is then decimalized by subtracting the hexadecimal value A from the extracted value resulting in a decimalized value ranging from zero to five 315. This decimalized value is then concatenated on the right to the right most value of the holding string 320.

Once all nibbles in Block G have been twice examined as described, the three most-significant (i.e. left-most) nibbles of the holding string are extracted 325. This 3-digit value is the dCVV for the transaction. Other numbers of bits may be extracted from the twice-examined nibble string to generate the dCVV for a transaction. Furthermore, different nibbles, such as the rightmost nibbles, may be used as the dCVV for a transaction. The three leftmost nibbles, however, represent a preferred embodiment.

Once generated, the dCVV is embedded into the payment data transmitted from the portable consumer device to the point of sale terminal. The data received by the point of sale terminal may appear to the point of sale terminal as standard payment data. In other words, the point of sale terminal may not be able to determine if a dCVV is embedded and where such dCVV may be located. There is no indication to the point of sale terminal that a dCVV is embedded into the data received from the portable consumer device.

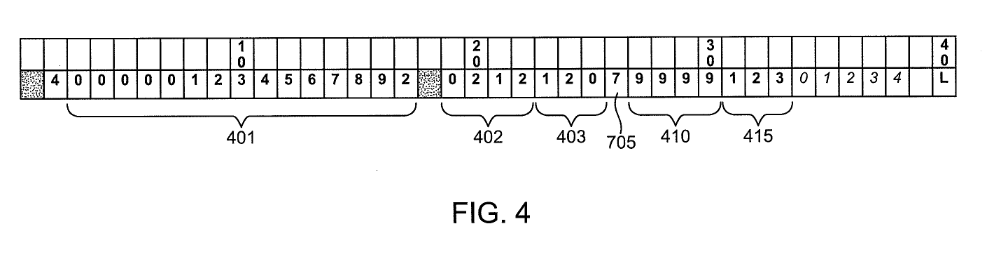

FIG. 4 depicts an exemplary record format for transmitting payment data, with the dCVV embedded therein, from the portable consumer device to the point of sale terminal. The record format of FIG. 4 is created by concatenating a primary account number 401 for the payment service, with an expiration date 402, and a service code 403. In one embodiment, the primary account number 401 is 16 digits long, the expiration date 402 is four digits long, and the service code 403 is three digits long. However, the primary account number 401, the expiration date 402, and the service code 403 are not limited to being these lengths. Next, in a field typically reserved for other uses, a value is placed as an indicator 705 that a dCVV has been embedded in this record. The value of this indicator is known by the service provider which deployed the application on the portable consumer device. Next, the ATC 410 is placed in the field which may typically be reserved for PIN verification data. Finally, the dCVV 415 is concatenated on the right of the record. The remainder of the record may comprise additional discretionary data.

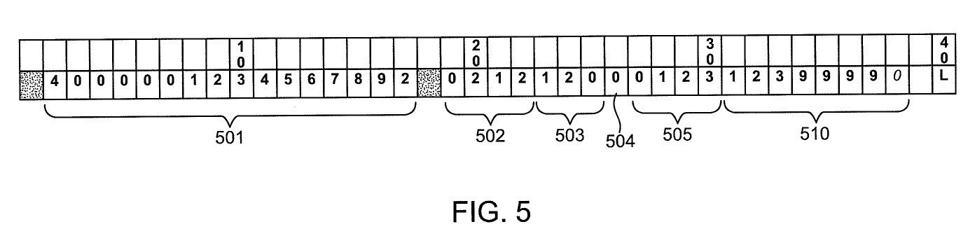

Alternately, FIG. 5 depicts a second exemplary format for transmitting payment information with the dCVV embedded thereon from the portable consumer device to the point of sale terminal. The format in FIG. 5 is created by concatenating a primary account number 501 for the payment service, with an expiration date 502, a service code 503, a PVKI 504, and a field for PIN verification data 505. In one embodiment, the primary account number 501 is sixteen digits long, the expiration date 502 is four digits long, the service code 503 is three digits long, the PVKI 504 is one digit long, and the PIN verification data 505 is four digits long. However, the primary account number 501, the expiration date 502, the service code 503, the PVKI 504, and the PIN verification data 505 are not limited to being these lengths. Next, in a single data field 510, each of the dynamically created CVV, the ATC and the indicator to be used by the service provider to identify that a dynamic CVV has been embedded are stored in sequence. The remainder of the record may comprise additional discretionary data.

In some embodiments, other data fields may be provided for longer card verification values. For example, PIN offset data fields and discretionary data fields can be used and/or re-purposed to provide for longer verification values (e.g., 5, 6, or even 8 characters long). Longer verification values are more desirable since they are more difficult to decrypt.

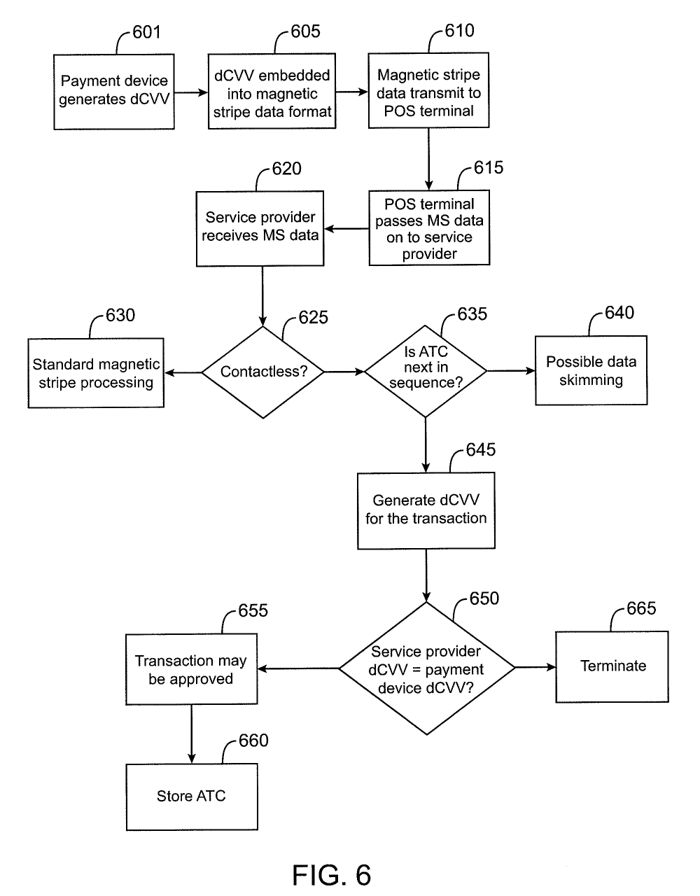

One aspect of the present invention is that the system of utilizing the dynamically created CVV allows the service provider to make a determination of the authenticity of the payment service being utilized. This authentication step need not be left to merchants, individual point of sale terminals, or other third parties or devices. FIG. 6 shows how the dCVV is used in a contactless environment to permit the service provider to evaluate the authenticity of the payment application deployed on the portable consumer device to make a determination of whether the payment application has been skimmed. Although shown in the embodiment of a contactless environment in FIG. 6, the present invention is not limited to such an environment and may be used for any transaction where magnetic stripe Track 1 and/or Track 2 data is exchanged using any method or means for communicating such data.

As shown in FIG. 6, the portable consumer device generates the dCVV 601, using the methodology described above. The dCVV is embedded into the payment data 605. In this respect, the exemplary record formats shown in FIG. 4 or FIG. 5 may be utilized. The payment data with the embedded dCVV is transmitted by data communication to the point of sale terminal 610. The point of sale terminal recognizes the received data as in the standard format of payment data and passes the data stream on to the service provider computer 615, likely via a payment network (not shown). The service provider computer receives 620 the payment data with the embedded dCVV and interrogates the appropriate indicator to determine if the transaction was a contactless transaction or not 625. If the service provider computer determines that the transaction was not a contactless transaction, the transaction is processed in its normal manner 630. If the service provider computer determines that the transaction was contactless, the service provider computer compares the ATC received from the portable consumer device to the corresponding ATC on the service provider computer to determine if the received ATC is the expected next ATC 635, and/or is within an allowable range.

In some embodiments, a computer such as a POS terminal can generate a first dynamic verification value, and it can be sent to a backend service provider computer (e.g., an issuer computer). The service provider computer is configured to independently generate a second dynamic verification value and determine if the first dynamic verification value is same as the second dynamic verification value or is within a range based on the second dynamic verification value. For example, a transaction may be considered authentic if the ATC is within an allowable range (e.g., within 5-10 of the derived second dynamic verification value). In some cases, a counter on a card or other portable consumer device may inadvertently increment (e.g., when a card is used as an identification tool for airline check-in), or may increment more quickly than expected (e.g., when an offline transaction is performed and wherein counter data in a backend computer is not updated immediately). Thus, if the ATC falls within a predetermined range, the counter may be considered authentic in some cases.

If the ATC received from the portable consumer device is not the expected next ATC or within the allowable range, the payment service deployed on the portable consumer device has potentially been skimmed 640. If the expected next ATC and/or an ATC that is within the allowable range is received, the service provider computer may independently re-generate the dCVV for the given transaction 645 utilizing a similar or analogous process as described above. If the service provider generated dCVV matches the dCVV received from the portable consumer device 650, or if the dCVV is one that can be generated using an ATC within the allowable range, the service provider deems the payment application to be authentic 655. The service provider computer then replaces the ATC which was previously stored on the service provider computer with the generated ATC received from the portable consumer device 660 for subsequent authentications. If the service provider generated dCVV does not match the dCVV, or is not one which is derived from an ATC within the allowable range, the transaction is potentially fraudulent and is terminated 665.

The methodology of FIG. 6 discussed in conjunction with contactless transactions, is not limited thereto. For example, the methodology may be utilized with respect to transactions above a certain threshold value. In such an instance, the service provider, upon deploying the application, would configure the application to generate a dCVV for transactions above the threshold. The indicator interrogated in Step 625 would then be set for transactions above the threshold value. Similarly, the methodology may be utilized with respect to any other transaction criteria including, but not limited to, geographic location, use patterns, or any other criteria.

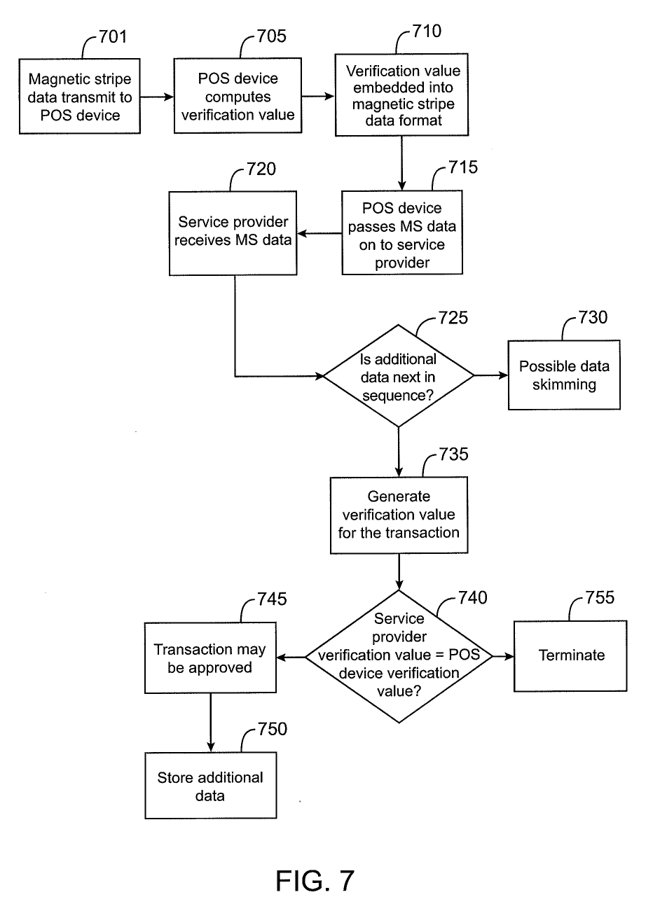

In an alternate embodiment (see FIG. 7), the portable consumer device transmits payment data to a point of sale terminal such as a credit card terminal 701. The point of sale terminal receives the data and computes a verification value for the transaction 705. The verification value may be computed in a number of different ways including, without limitation, using a unique transaction number provided by the point of sale terminal, a timestamp, or a transaction amount added to a timestamp. The point of sale terminal may then embed and/or append the verification value and additional data to the payment data 710. The additional data may be required for the service provider computer to verify the transaction. The point of sale terminal then passes the data stream on to the service provider computer 715, likely via a payment network (not shown). The service provider computer receives the payment data with the verification value 720. The service provider computer may optionally compare at least a portion of the additional data embedded or appended by the point of sale terminal to corresponding data stored on the service provider computer to determine if the received data is proper 725, and/or is within a predetermined range. If the received data from the point of sale terminal is improper, the transaction data may potentially have been skimmed 730. If proper data, the service provider computer may independently re-generate the verification value for the given transaction utilizing the same process as used by the point of sale terminal 735. If the service provider generated verification value matches the verification value received from the point of sale terminal 740, of if the generated verification value is otherwise acceptable (e.g., the verification value is generated using dynamic data elements that are within acceptable ranges), the service provider deems the payment application to be authentic 745. The service provider computer may then optionally update the additional data which was previously stored on the service provider computer with the additional data received from the portable consumer device for subsequent authentications 750. If the service provider generated verification value does not match the verification value received from the point of sale terminal, or is otherwise not acceptable, the transaction is potentially fraudulent and is terminated 755.

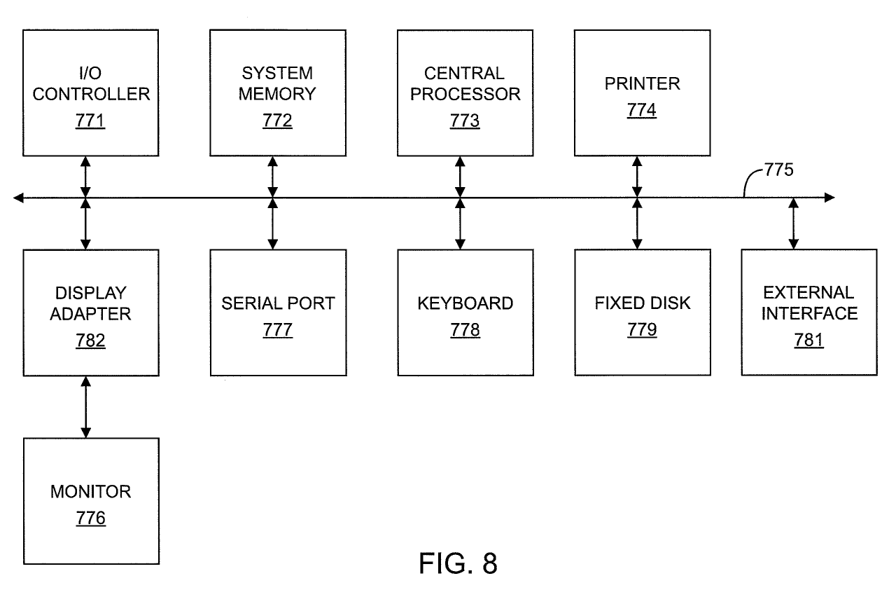

Any of the computers described herein including the service provider computer, POS terminal, and even some portable consumer device embodiments, may utilize any suitable number or combination of subsystems. Examples of such subsystems or components are shown in FIG. 8. The subsystems shown in FIG. 8 are interconnected via a system bus 775. Additional subsystems such as a printer 774, keyboard 778, fixed disk 779, monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

The foregoing is considered as illustrative only of the principles of the invention. Further, since numerous modifications and changes may readily occur to those skilled in the art, it is not desired to limit the invention to the exact construction and operation shown and described, and accordingly, all suitable modifications and equivalents may be resorted to, falling within the scope of the invention.

What is claimed is:

1. A method comprising:
generating a uniquely derived data string using personalized information and a first encryption algorithm;
generating at least one uniquely derived key using the uniquely derived data string; and
creating a dynamic verification value using a second encryption algorithm using the at least one uniquely derived key, wherein the first encryption algorithm is different than the second encryption algorithm.

2. The method of claim 1 wherein the first encryption algorithm comprises an AES encryption algorithm.

3. The method of claim 1 wherein the second encryption algorithm is a DES or triple DES encryption algorithm.

4. The method of claim 1 wherein the personalized information comprises a primary account number and an account sequence number.

5. The method of claim 1 wherein creating the dynamic verification value using the second encryption algorithm comprises:
encrypting the personalized information using the at least one uniquely derived key using the second encryption algorithm.

6. The method of claim 1 wherein creating the dynamic verification value using the second encryption algorithm comprises:
concatenating a counter with the personalized information, and then encrypting the concatenated counter and personalized information using the second encryption algorithm.

7. The method of claim 1 wherein the dynamic verification value is a first dynamic verification value, and wherein the method further comprises sending the first dynamic verification value to a service provider computer, wherein the service provider computer determines if an independently generated second dynamic verification value matches the first dynamic verification value.

8. The method of claim 1 wherein the dynamic verification value is a card verification value.

9. The method of claim 1 wherein the first encryption algorithm is an AES encryption algorithm and wherein the second encryption algorithm is a DES or triple DES encryption algorithm.

10. A computer readable medium comprising:
code for generating a uniquely derived data string using personalized information and a first encryption algorithm;
code for generating at least one uniquely derived key using the uniquely derived data string; and
code for creating a dynamic verification value using a second encryption algorithm using the at least one uniquely derived key, wherein the first encryption algorithm is different than the second encryption algorithm.

11. The computer readable medium of claim 10 wherein the first encryption algorithm comprises an AES encryption algorithm.

12. The computer readable medium of claim 10 wherein the first encryption algorithm is an AES encryption algorithm and wherein the second encryption algorithm is a DES or triple DES encryption algorithm.

13. The computer readable of claim 10 wherein the personalized information comprises a primary account number and an account sequence number.

14. The computer readable medium of claim 10, wherein the computer readable medium is in the form of a chip and is adapted for use in a phone or smartcard.

15. A computer comprising:
a processor; and
a computer readable medium comprising instructions, executable by the processor, for generating a uniquely derived data string using personalized information and a first encryption algorithm, generating at least one uniquely derived key using the uniquely derived data string, and creating a dynamic verification value using a second encryption algorithm using the at least one uniquely derived key, wherein the first encryption algorithm is different than the second encryption algorithm.

16. The computer of claim 15 wherein the first encryption algorithm comprises an AES encryption algorithm.

17. The computer of claim 15 wherein the first encryption algorithm is an AES encryption algorithm and wherein the second encryption algorithm is a DES or triple DES encryption algorithm.

18. The computer of claim 15 wherein the personalized information comprises a primary account number and an account sequence number.

19. The computer of claim 15 wherein creating the dynamic verification value using the second encryption algorithm comprises:
encrypting the personalized information using the at least one uniquely derived key.

20. The computer of claim 15 wherein the dynamic verification value is a first dynamic verification value, and wherein the method further comprises sending the first dynamic verification value to a service provider computer, wherein the service provider computer determines if an independently generated second dynamic verification value matches the first dynamic verification value.

21. The computer of claim 15 wherein the computer is in the form of a POS terminal.

22. The computer of claim 15 wherein the computer is a service provider computer.

23. The computer of claim 15 wherein the computer is adapted to process financial transactions.

24. The computer of claim 15 wherein the computer is in the form of a portable consumer device.

25. A system comprising:
the computer of claim 15, wherein the computer is a POS terminal and the verification value is a first dynamic verification value; and
a service provider computer operatively coupled to the POS terminal, wherein the service provider computer is configured to independently generate a second dynamic verification value and determine if the first dynamic verification value is same as the second dynamic verification value or is within a range based on the second dynamic verification value.
